(19) United States
(12) Patent Application Publication
(10) Pub. No.: US 2017/0082449 A1
(43) Pub. Date: Mar. 23, 2017

(54) DRIVING ASSISTANCE DEVICE

(71) Applicant: DENSO CORPORATION, Kariya-city, Aichi-pref. (JP)

(72) Inventor: Takamitsu SUZUKI, Kariya-city (JP)

(21) Appl. No.: 15/310,482

(22) PCT Filed: May 25, 2015
(86) PCT No.: PCT/JP2015/002633

§ 371 Date: Nov. 11, 2016

(30) Foreign Application Priority Data
Jun. 4, 2014 (JP) 2014-115955

(51) Int. Cl. G01C 21/34; G08G 1/0968; G09B 29/10; G01C 21/36

(52) U.S. Cl. CPC G01C 21/3484; G01C 21/3667; G08G 1/096844; G01C 21/3641; G09B 29/10; B60K 35/00

(57) ABSTRACT

A driving assistance device used for a vehicle includes: a display processing device that displays a map on a display device; an immature pattern identification device that identifies an immature pattern inexperienced by a driver of the vehicle among multiple patterns with predetermined types into which multiple components of a road network included in the map are classified; and an accessible area identification device that identifies an accessible area to which the vehicle is reachable from a set start point without passing through the immature pattern identified by the immature pattern identification device. The display processing device controls the display device to display the map on which the accessible area identified by the accessible area identification device is superimposed.

### CROSS REFERENCE TO RELATED APPLICATION

This application is based on Japanese Patent Application No. 2014-115955 filed on Jun. 4, 2014, the disclosure of which is incorporated herein by reference.

### TECHNICAL FIELD

The present disclosure relates to a driving assistance device that supports the driving of a driver with the provision of information to the driver.

### BACKGROUND ART

In a movement by a vehicle, there is a pleasure to freely selectively travel on a road network spread throughout the country. On the other hand, there is a point that becomes a dangerous place such as a point making difficult to go by an oncoming vehicle or a point making a lane change or confluence difficult depending on a driver's driving experience, as a result of which an action area may be limited by a psychological load.

Under the circumstances, as means for solving the above problem, Patent Literature 1 discloses a technique in which dangerous places in which driving operation is assumed to be difficult are registered in advance, and a route that does not pass through the registered dangerous places is calculated in a route calculation from the present position to a destination, and guided.

However, in the technique disclosed in Patent Literature 1, with the guidance of the route avoiding the dangerous places, the psychological load of the driver insufficiently experiencing the dangerous places when passing through the dangerous places can be reduced. However, because the driver does not know when to come across the points which are the dangerous places when deviating from the guided route, there is a problem that the pleasure that the driver can freely selectively travel on the road network is hardly obtained.

### PRIOR ART LITERATURES

### Patent Literature

Patent Literature 1: JP-2004-170347-A1

### SUMMARY OF INVENTION

It is an object of the present disclosure to provide a driving assistance device which is capable of reducing a psychological load when a driver passes through an inexperienced point while easily obtaining a pleasure of freely selectively traveling on a road network.

According to an aspect of the present disclosure, a driving assistance device used for a vehicle includes: a display processing device that displays a map on a display device; an immature pattern identification device that identifies an immature pattern inexperienced by a driver of the vehicle among a plurality of patterns with predetermined types into which a plurality of components of a road network included in the map are classified; and an accessible area identification device that identifies an accessible area to which the vehicle is reachable from a set start point without passing through the immature pattern identified by the immature pattern identification device. The display processing device controls the display device to display the map on which the accessible area identified by the accessible area identification device is superimposed.

According to the above driving assistance device, since the accessible area in which the vehicle is reachable without allowing the driver of the vehicle to pass through the inexperienced components of the road network is superimposed on a map, and provided to the driver, the drive can know the accessible area in which the driver can travel without passing through the inexperienced points even if freely selectively traveling on the road network. Hence, the driver can freely selectively travel on the road network within the accessible area with a sense of security that it is unnecessary to pass through the inexperienced points. As a result, the psychological load of the driver who passes through the inexperienced points can be reduced while easily obtaining the pleasure of freely selectively traveling on the road network.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram illustrating an example of a schematic configuration of a driving support system 100;

FIG. 2 is a block diagram illustrating an example of a schematic configuration of a control unit 7 according to a first embodiment;

FIG. 3 is a flowchart illustrating an example of a flow of a map network patterning process by a pattern determination unit 71 of the control unit 7;

FIG. 4 is a flowchart illustrating an example of a flow of an experience number learning process by a learning unit 72 of the control unit 7;

FIG. 5 is a flowchart illustrating an example of a flow of an accessible area display process by the control unit 7;

FIG. 6 is a diagram illustrating an example of a display of the accessible area;

FIG. 7 is a flowchart illustrating an example of a flow of an overcoming informing process by the control unit 7;

FIG. 8 is a block diagram illustrating a schematic configuration of a control unit 7 according to a modification 4;

FIG. 9 is a flowchart illustrating an example of a flow of a ranking display process by the control unit 7;

FIG. 10 is a diagram illustrating an example of a display of a result obtained by ranking according to a size of the accessible area spreading when overcoming a bottleneck pattern;

FIG. 11 is a diagram illustrating an example of a display of a post-overcoming accessible area;

FIG. 12 is a diagram illustrating an example of a configuration in which the post-overcoming accessible area and an accessible area before overcoming the bottleneck pattern are comparably displayed;

FIG. 13 is a block diagram illustrating a schematic configuration of a control unit 7 according to a modification 7;

FIG. 14 is a flowchart illustrating an example of a flow of an overcoming target display process by the control unit 7;

FIG. 15 is a block diagram illustrating a schematic configuration of a control unit 7 according to a modification 8; and

FIG. 16 is a flowchart illustrating an example of a flow of an overcoming time arrival facility display process by the control unit 7.

### EMBODIMENTS FOR CARRYING OUT INVENTION

### First Embodiment

### Schematic Configuration of Driving Support System 100

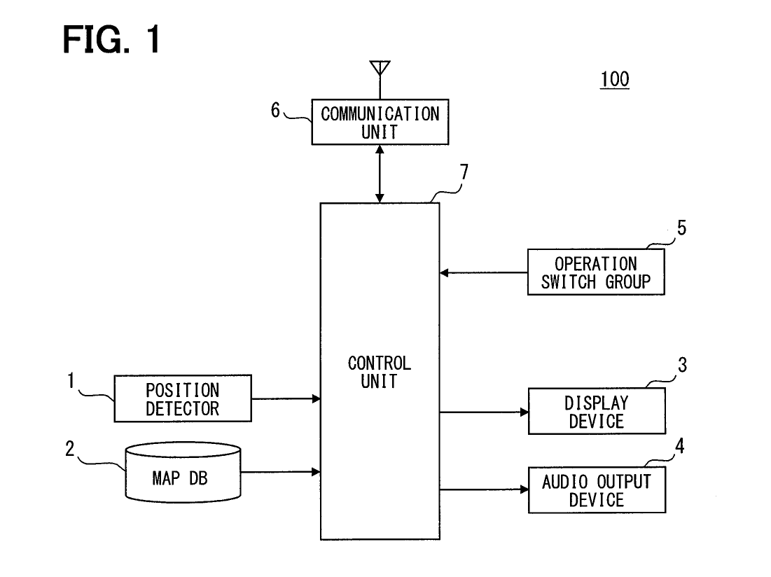

FIG. 1 is a diagram illustrating an example of a schematic configuration of a driving support system 100 according to the present disclosure. The driving support system 100 is used for a vehicle, and includes a position detector 1, a map DB 2, a display device 3, an audio output device 4, an operation switch group 5, a communication unit 6, and a control unit 7 as illustrated in FIG. 1. Hereinafter, a vehicle using the driving support system 100 is called “subject vehicle”.

The position detector 1 sequentially detects a present position (hereinafter referred to as “subject vehicle position”) of the subject vehicle with the use of a positioning system for detecting the subject vehicle position on the basis of radio waves from, for example, a positioning satellite. The subject vehicle position is represented by coordinates of a latitude and a longitude.

The map DB 2 stores data of a road map, POI (points of interest) data of various facilities. The data of the road map includes road data having node data and link data. The POI data includes data indicative of names, addresses, positions, and attributes of the facilities corresponding to the POI.

The link data includes respective data of unique numbers (link IDs) for identifying the respective links, link lengths indicative of lengths of the respective links, shape information on the links, segment lengths indicative of lengths of respective segments, start and end node coordinates (latitude/longitude) of the links, road names, road types, road widths, the number of lanes, the presence or absence of exclusive lanes of right turn and left turn, the number of exclusive lanes, traffic regulations such as one-way traffic, speed limit values, and so on.

On the other hand, the node data includes respective data of node IDs having a unique number for each of nodes on the map, node coordinates, node names, connection link IDs describing link IDs of links connected to each node, intersection types, and so on.

The data of the positions of the facilities is indicated, for example, by coordinates of latitude and longitude. The data of the attributes of the facilities represents the types and natures of the facilities. As an example of the types of the facilities, there are stores such as restaurants and recreational facilities such as theme parks. As an example of the nature of the facilities, there is ranking of the number of customer arrivals, evaluations, or the like.

The data of the map DB 2 may be acquired by being downloaded by the control unit 7 from a center through the communication unit 6 which will be described later, or may be stored in advance.

The display device 3 displays texts and images according to an instruction from the control unit 7. For example, the display device 3 enables full-color display, and can be configured by a liquid crystal display or the like. The display device 3 may be configured by a display installed on an instrument panel or the like, or may be configured by an HUD (head-up display). The audio output device 4 is configured by a speaker or the like, and outputs a voice according to an instruction from the control unit 7.

The operation switch group 5 is formed of, for example, touch switches integrated with the display device 3, mechanical switches, or the like, and instructs the control unit 7 to operate the various functions through the switch operation.

The communication unit 6 performs a communication with the center through, for example, a roadside unit, a base station, or a network. The communication unit 6 can be configured by a vehicle communication module used for a telematics communication such as a DCM (data communication module) or the like, or a vehicle-mounted compact communication equipment that receives traffic information transmitted from radio wave beacons or optical beacons installed on the roads.

The control unit 7 is configured mainly as a microcomputer, and includes memories such as a CPU, a ROM, and a RAM, an I/O, and a bus connecting those components to each other, all of which are well known. The control unit 7 executes various processing on the basis of various information input from the position detector 1, the map DB 2, the operation switch group 5, and the communication unit 6. The control unit 7 corresponds to a driving assistance device defined in the claims.

Meanwhile, a part or all of the functions to be executed by the control unit 7 may be configured by one or multiple ICs or the like in a hardware fashion.

<Detailed Configuration of Control Unit 7 According to First Embodiment>

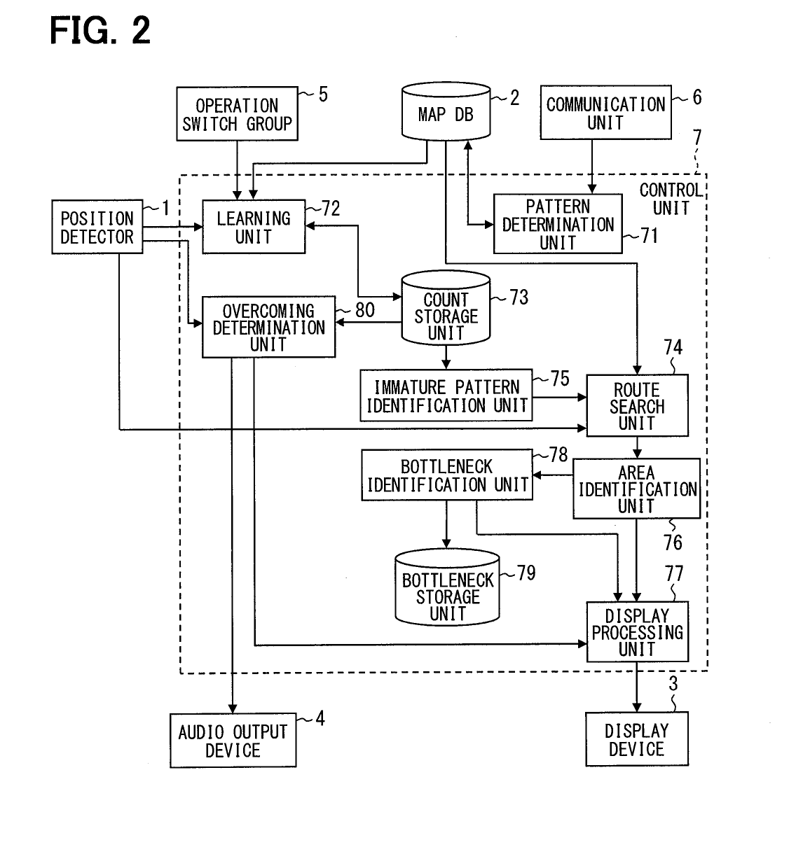

As illustrated in FIG. 2, the control unit 7 includes a pattern determination unit 71, a learning unit 72, a count storage unit 73, a route search unit 74, an immature pattern identification unit 75, a area identification unit 76, a display processing unit 77, a bottleneck identification unit 78, a bottleneck storage unit 79, and an overcoming determination unit 80. The processing in the respective units of the control unit 7 will be described in detail later.

<Map Network Patterning Process>

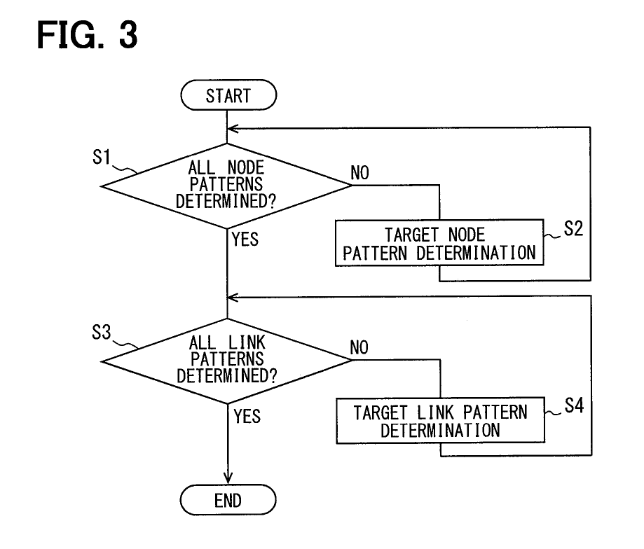

Now, a map network patterning process in the pattern determination unit 71 of the control unit 7 will be described with reference to the flowchart of FIG. 3. The map network patterning process is a process related to a pattern determination for determining to which of classified plural types of patterns all the links and all the nodes included in the map DB 2 correspond. As an example, a flowchart of FIG. 3 starts when the driving support system 100 is initially used or when the road map data of the map DB 2 has been updated.

In the pattern determination, the nodes (that is, intersections) and the links (that is, roads) are patterned on the basis of information to be considered by the driver when the vehicle passes through the nodes and the links. For example, the node patterns are classified by intersection shapes such as “T-junction”, “crossroad”, “five or more forked road”, and “confluence”, and signal rules such as “no exclusive right turn signal” and “no walking/vehicle separation signal”. The link patterns are classified by road conditions such as “speed limit value is high”, “road width is narrow”, “four or more lanes”, “heavy traffic”, “heavy traffic of large size vehicles”, and so on.

In the road conditions such as “heavy traffic” and “heavy traffic of the large size vehicles”, for example, traffic information that is received by the communication unit 6 may be used.

Because the map network (that is, road network) is basically configured by the nodes and the links, all of the nodes and all of the links are subjected to the pattern determination.

First, in Step S1, if the pattern determination is not completed on all of the nodes in the map DB 2 (no in S1), the process proceeds to Step S2. On the other hand, if the pattern determination is completed for all of the nodes (yes in S1), the process proceeds to Step S3. Since the pattern determination is not performed immediately after the flowchart of FIG. 3 has been started, the process proceeds to S2.

In Step S2, the pattern determination is performed for the nodes not subjected to the pattern determination among the nodes whose data is stored in the map DB 2. As a result of performing the pattern determination on those nodes, if the nodes correspond to the respective classified node patterns, the node patterns are stored in association with the respective nodes, for example, in the map DB 2.

As an example, if the node corresponds to the node pattern “confluence”, the pattern determination unit 71 stores the node in association with the node pattern “confluence” in the map DB 2. When multiple types of node patterns correspond to one node, the multiple types of node patterns may be stored in association with the node.

In Step S3, if the pattern determination is not completed on all of the links in the map DB 2 by the pattern determination unit 71 (no in S3), the process proceeds to Step S4. On the other hand, if the pattern determination has been competed on all of the links (yes in S3), the map network patterning process is completed.

In Step S4, the links not subjected to the pattern determination among the links whose data is stored in the map DB 2 are subjected to the pattern determination. As a result of performing the pattern determination on the links, if the links correspond to the respective classified link patters, the link patterns are stored in the map DB 2 in association with the respective links.

As an example, if the links correspond to the link pattern “road width is narrow”, the pattern determination unit 71 stores the links in the map DB 2 in association with the link pattern “road width is narrow”. When multiple types of link patterns correspond to one link, the multiple types of link patterns may be stored in association with the link.

In this example, it is determined to which of the classified multiple types of patterns all of the links and all of the nodes included in the map DB 2 correspond by the control unit 7, and the respective determined patterns are stored in the map DB 2 in association with the links and the nodes. However, the present disclosure is not always limited to this configuration. For example, data in which the appropriate pattern is associated with the link and the pattern for all of the links and all of the nodes in advance may be stored in the map DB 2 in advance. The data may be downloaded by the control unit 7 through the communication unit 6, and stored in the map DB 2.

<Experience Number Learning Process>

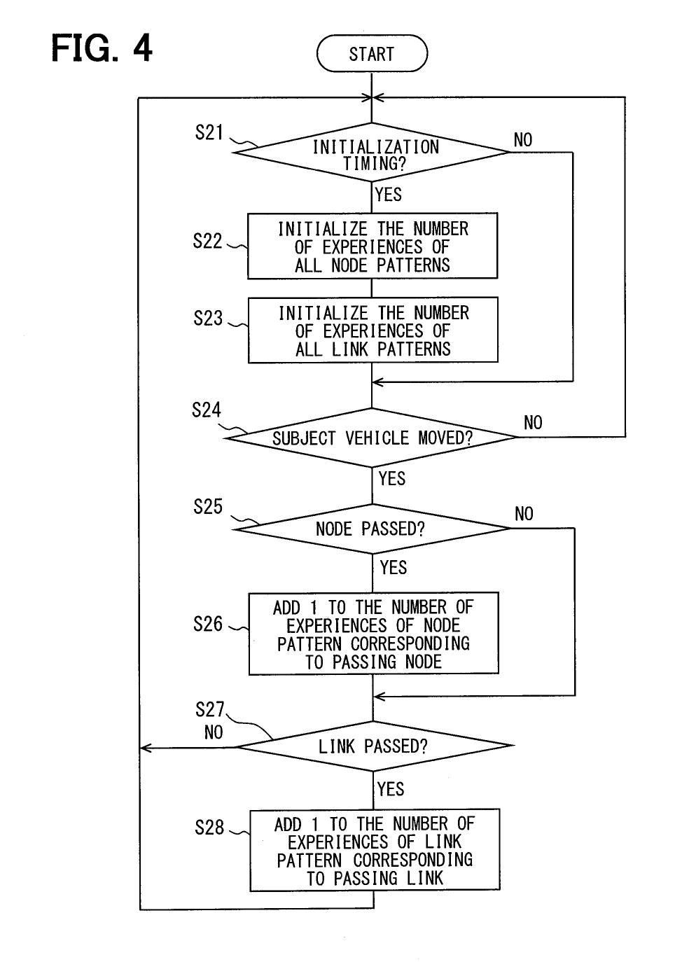

Subsequently, an experience number learning process by the learning unit 72 of the control unit 7 will be described with reference to a flowchart of FIG. 4. The experience number learning process is a process for counting the number of experiences indicative of how the driver has experienced each node pattern and each link pattern. The number of experiences counted for each node pattern and each link pattern is stored in the count storage unit 73 for each node pattern and each link pattern. For example, the node pattern “confluence” is stored in association with “1” in the number of experiences, and the node pattern “crossroad” is stored in association with “8” in the number of experiments.

As an example, the flowchart of FIG. 4 is started when the driving support system 100 is initially used, and interrupted when the control unit 7 is powered off.

First, in Step S21, if initialization timing comes (yes in S21), the process proceeds to Step S22. On the other hand, if no initialization timing comes (no in S21), the process proceeds to Step S24. An example of the initialization timing is when the driving support system 100 is initially used, or when a driver requests an initialization through the operation switch group 5.

In Step S22, the number of experiences of all the node patterns in the count storage unit 73 is initialized. In other words, the number of experiences of all the node patterns is set to 0. In Step S23, the number of experiences of all the link patterns in the count storage unit 73 is initialized. In other words, the number of experiences of all the link patterns is set to 0.

In Step S24, it is determined whether the subject vehicle travels, or not, for example, depending on whether the subject vehicle position sequentially detected by the position detector 1 is varied, or not. If it is determined that the subject vehicle travels (yes in S24), the process proceeds to Step S25. On the other hand, if it is determined that the subject vehicle does not travel (no in S24), the process returns to S21, and repeats the processing.

In Step S25, it is determined whether the subject vehicle has passed through the node, or not, on the basis of the node data stored in the map DB 2 and the subject vehicle position sequentially detected by the position detector 1. As an example, when the subject vehicle position sequentially detected has passed beyond the node, it is determined that the subject vehicle has passed through the node. If it is determined that the subject vehicle has passed through the node (yes in S25), the process proceeds to Step S26. On the other hand, if it is determined that the subject vehicle has not passed through the node (no in S25), the process proceeds to Step 27.

In Step S26, in the node pattern associated with the node determined to be passed in S25 in the map DB 2, the number of experiences stored in the count storage unit 73 is incremented by 1. For example, when the node pattern “crossroad” is associated with the passing node, the number of experiences of the node pattern “crossroad” stored in the count storage unit 73 is incremented by 1, and the process proceeds to Step S27. When the node pattern associated with the node determined to be passed in S25 in the map DB 2 is not present, the process proceeds to Step S27 without incrementing the number of experiences.

In Step S27, it is determined whether the subject vehicle has passed through the link on the basis of the link data stored in the map DB 2 and the subject vehicle position sequentially detected by the position detector 1. As an example, when the subject vehicle position sequentially detected has passed beyond end node coordinates of the link, it is determined that the subject vehicle has passed through the link. If it is determined that the subject vehicle has passed through the link (yes in S27), the process returns to Step S28. On the other hand, if it is determined that the subject vehicle has not passed through the link (no in S27), the process returns to Step S21, and repeats the processing.

In Step S28, in the link pattern associated with the link determined to be passed in S27 in the map DB 2, the number of experiences stored in the count storage unit 73 is incremented by 1, and the process returns to S21 and repeats the processing. For example, when the link pattern “road width is narrow” is associated with the passing link, the number of experiences of the link pattern “road width is narrow” stored in the count storage unit 73 is incremented by 1. When the link pattern associated with the link determined to be passed in S27 in the map DB 2 is not present, the process returns to Step S21 without incrementing the number of experiences, and repeats the processing.

<Accessible Area Display Process>

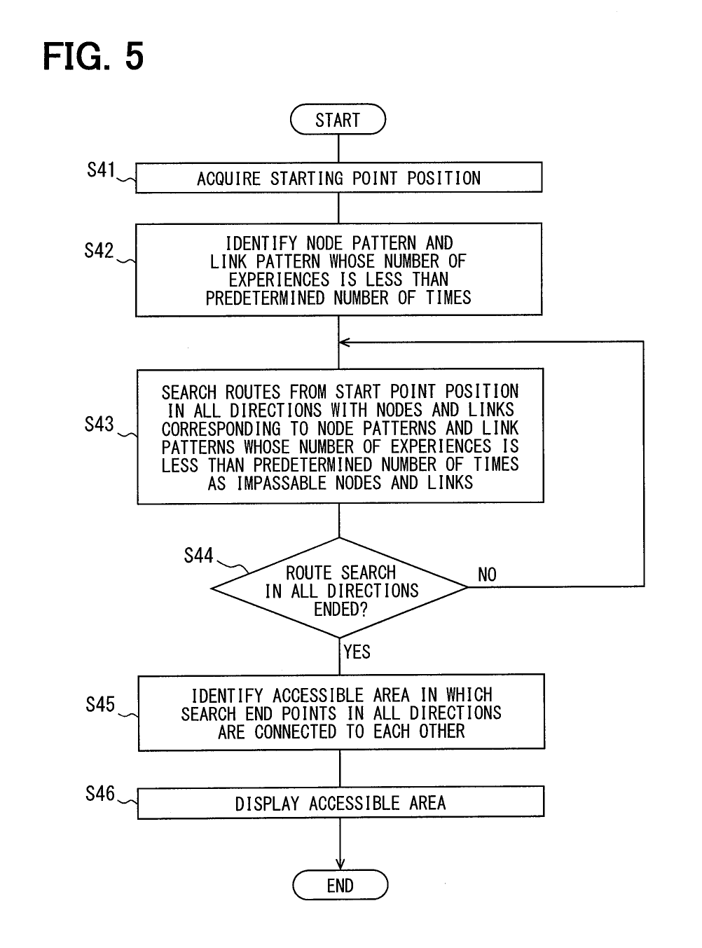

Subsequently, an accessible area display process in the control unit 7 will be described with reference to a flowchart of FIG. 5. The accessible area display process is a process for displaying the accessible area taking the passing experiences of the link pattern and the node pattern of the driver into consideration. As an example, the flowchart of FIG. 5 may be started when the driver requests a display of the accessible area through the operation switch group 5.

In Step S41, the route search unit 74 acquires a start point position. As an example, the subject vehicle position detected by the position detector 1 may be acquired as the start point position, or if a home position of the driver can be acquired, the home position of the driver may be acquired as the start point position.

In Step S42, the immature pattern identification unit 75 identifies the node pattern and the link pattern whose number of experiences is less than a predetermined number of times on the basis of the storage of the count storage unit 73. The predetermined number of times may be a settable value, for example, once, or may be adjusted to more than once according the driver's experience years or the driver's experience distance. In addition, the number of times may be set by the driver through the operation switch group 5.

In Step S43, the route search unit 74 sets the nodes and the links corresponding to the node patterns (hereinafter referred to as “immature node patterns”) and the link pattern (hereinafter referred to as “immature link pattern”) whose number of experiences is identified to be less than the predetermined number of times in S42 as impassable nodes and links, and searches the route from the start point position acquired in S41 toward all of directions. The immature node patterns and the immature link patterns correspond to immature patterns defined in the claims.

In the route search referred to herein, a route to a search end point reachable according to the traffic regulations such as one-way traffic without passing through the same link twice or more is searched. The search end point includes a node corresponding to the immature node pattern, a start node of the link corresponding to the immature link pattern, and an end node of the link corresponding to a dead end. In addition, the route search sequentially performs a search of branches on the way of the search end point in all directions travelable from the start point position.

If the route search in all directions is completed in Step S44 (yes in S44), the process proceeds to Step S45. On the other hand, if the route search is not completed (no in 44), the process returns to S43, and the processing of the route whose search is not completed is repeated.

In Step S45, the area identification unit 76 identifies an area surrounded by connecting search end points of the multiple routes obtained as a result of performing the route search in all directions by the route search unit 74 to each other as the accessible area. The area identification unit 76 corresponds to an accessible area identification unit defined in the claims. When the search end points of the multiple routes are connected to each other, the search end points adjacent to each other in a circumferential direction with the start point position as a center may be sequentially connected to each other.

The bottleneck identification unit 78 identifies the immature node patterns and the immature link patterns corresponding to the search end points used for identification of the accessible area by the area identification unit 76 as bottleneck patterns that cause barriers narrowing the accessible area. In other words, the bottleneck identification unit 78 identifies the immature node patterns and the immature link patterns causing the area to be defined into the accessible area identified by the area identification unit 76 as the bottleneck patterns. The bottleneck identification unit 78 stores the identified bottleneck patterns in the bottleneck storage unit 79. As an example, the bottleneck identification unit 78 may store a list of the immature node patterns and the immature link patterns identified as the bottleneck patterns in the bottleneck storage unit 79. The bottleneck patterns correspond to barrier patterns defined in the claims.

In Step S46, the display processing unit 77 causes the display device 3 to perform a display in which the accessible area identified in S45 is superimposed on the map on the basis of the data stored in map DB 2 and the accessible area identified in S45, and completes the accessible area display process. In the present embodiment, an example in which the start point position acquired in S41 and the bottleneck patterns identified in the bottleneck identification unit 78 are superimposed on the map and displayed will be described below.

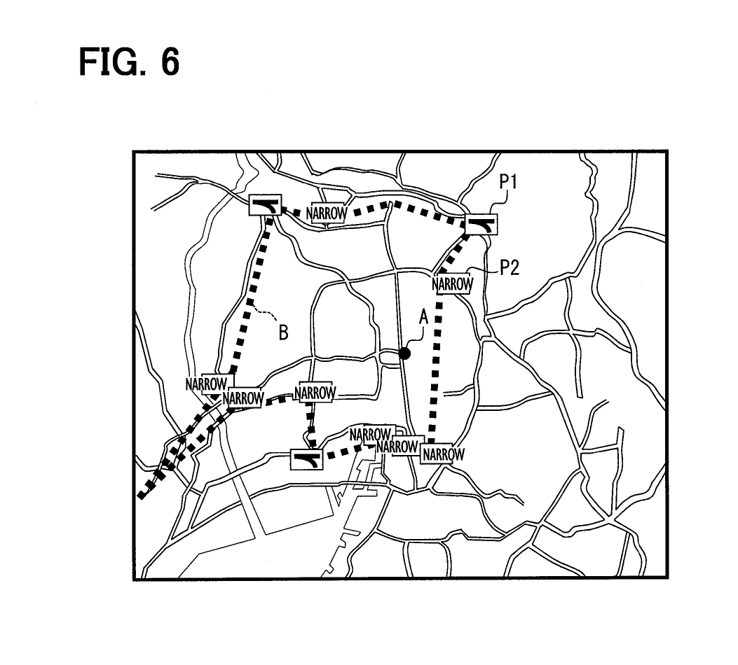

An example of the display of the accessible area will be described with reference to FIG. 6. In FIG. 6, an example in which the bottleneck patterns have the node pattern “confluence” and the link pattern “road width is narrow” will be described. In FIG. 6, symbol A indicates a start point position, an area surrounded by a dotted line of B indicates an accessible area, P1 shows an icon indicative of the node pattern “confluence”, and P2 shows an icon indicative of the bottleneck pattern “road width is narrow”.

As shown in FIG. 6, the accessible area and the start point position are displayed so as to be superimposed on the map. The icons indicative of the types of the bottleneck patterns are displayed at the positions of the bottleneck patterns corresponding to boundary points of the accessible area.

<Overcoming Informing Process>

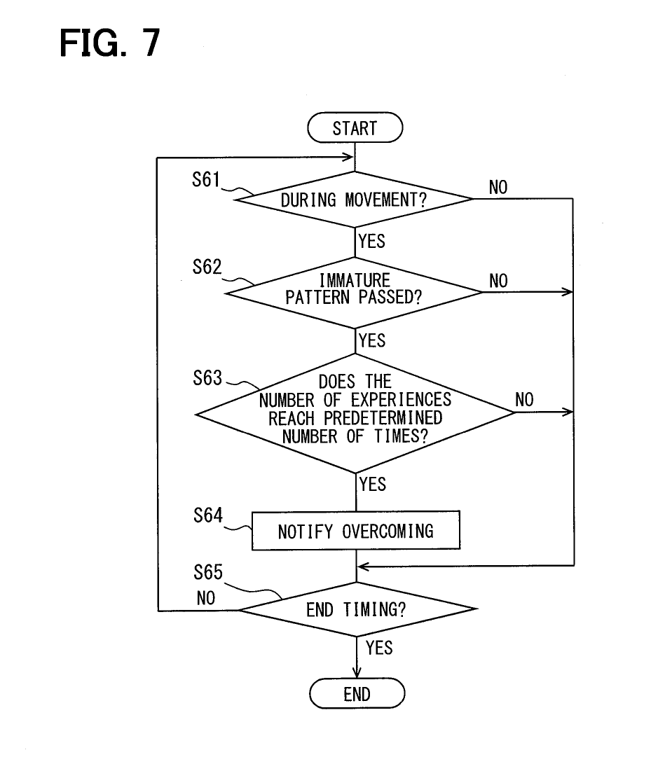

Subsequently, an overcoming informing process in the control unit 7 will be described with reference to a flowchart of FIG. 7. The overcoming informing process determine whether the driver has overcome the immature node patterns and the immature link patterns, or not, and if it is determined that the driver has overcome the immature node patterns and the immature link patterns, the overcoming informing process informs that overcoming has been performed. As an example, the flowchart of FIG. 7 may be started when an ignition power of the subject vehicle turns on to power on the control unit 7.

First, as in S24, the overcoming determination unit 80 determines whether the subject vehicle travels, or not, in Step S61. If it is determined that the subject vehicle travels (yes in S61), the process proceeds to Step S62. On the other hand, if it is determined that the subject vehicle does not travel (no in S61), the process proceeds to Step S65.

In Step S62, the overcoming determination unit 80 determines whether the subject vehicle has passed through the nodes corresponding to the immature node patterns and the links corresponding to the immature link patterns (hereinafter referred to as “immature patterns”), or not, on the basis of the number of experiences of each node pattern and each link pattern stored in the count storage unit 73, the node data stored in the map DB 2, and the subject vehicle position sequentially detected by the position detector 1.

More specifically, when the subject vehicle position sequentially detected passes beyond the nodes and the links, and the number of experiences of the node patterns and the link patterns associated with the nodes and the links is less than the above-mentioned predetermined number of times, the overcoming determination unit 80 determines that the subject vehicle has passed through the immature patterns. If it is determined that the subject vehicle has passed through the immature patterns (yes in S62), the process proceeds to Step S63. On the other hand, if it is determined that the subject vehicle has not passed through the immature patterns (no in S62), the process proceeds to Step S65.

In Step S63, the overcoming determination unit 80 determines whether the number of experiences of the node patterns and the link patterns corresponding to the immature patterns has reached the above-mentioned predetermined number of times by allowing the subject vehicle to have passed through the immature patterns, or not. If it is determined that the number of experiences has reached the predetermined number of experiences (yes in S63), the process proceeds to Step S64. On the other hand, if it is determined that the number of experiences has not reached the predetermined number of experiences (no in S63), the process proceeds to Step S65.

In Step S64, the overcoming determination unit 80 instructs the audio output device 4 to output a voice indicating that the immature patterns have been overcome, or the display processing unit 77 causes the display device to display that the immature patterns have been overcome. Thus, the overcoming determination unit 80 informs the driver of a fact that the immature patterns have been overcome.

Meanwhile, during the traveling of the subject vehicle, only the audio output of the display and the audio output may be performed, and during the stop of the subject vehicle, the display may be performed. In addition, a simple display such as “confluence clear” may be performed during the travel of the subject vehicle whereas a more detailed content may be displayed during the stop of the subject vehicle.

In Step S65, if it is an end timing of the overcoming informing process (yes in S65), the overcoming informing process is completed. If it is not the end timing of the overcoming informing process (no in S65), the process returns to S61, and the processing is repeated. An example of the end timing of the overcoming informing process is a timing when an ignition power supply of the subject vehicle is turned off to power off the control unit 7.

### Conclusion of First Embodiment

According to the configuration of the first embodiment, since the accessible area in which the driver can travel without passing through the immature patterns whose number of experiences passed by the driver is less than the predetermined number of times is superimposed on the map and provided to the driver, the driver can know the accessible area in which the driver can travel without passing through the inexperienced points even if the driver freely selectively travels on the road network.

Hence, the driver can freely selectively travel on the road network within the accessible area with a sense of security that it is unnecessary to pass through the inexperienced points. As a result, the psychological load of the driver who passes through the inexperienced points can be reduced while easily obtaining the pleasure of freely selectively traveling on the road network.

In addition, according to the configuration of the first embodiment, since the display of the icon indicative of the type of the bottleneck patterns causing the barrier narrowing the accessible area, that is, the display indicative of the bottleneck patterns which are the immature patterns causing the accessible area to be narrowed is performed, the driver can know what bottleneck patterns should be overcome to expand the accessible area. Further, the driver recognizes what bottleneck patterns should be overcome to expand the accessible area whereby the driver is motivated to overcome the bottleneck patterns, and the psychological load when passing through the bottleneck patterns can be reduced.

Further, as illustrated in FIG. 6, since the display indicative of the bottleneck patterns together with the accessible area is performed at the position of the bottleneck pattern on the map, even if the driver travels toward the bottleneck patterns, the driver can know what bottleneck pattern the driver travels toward in advance. From this viewpoint, the psychological load when passing through the bottleneck pattern can be reduced.

In addition, when the immature patterns have been overcome, since the driver is informed about a fact that the immature patterns has been overcome, the driver can challenge to overcome the immature patterns while enjoying game sensation, and can reduce the psychological load when passing through the inexperienced points.

Further, there is an advantage when applied to the driving abroad. For example, even in the driver rich in the driving experience, if the driver goes abroad, the driver may be sometimes confused by unfamiliar traffic rules. In response to this, according to the configuration of the first embodiment, the driving support system 100 is used in the vehicle even when going abroad, as a result of which the points of the patterns not experienced by the driver can be grasped in advance. Further, the psychological load when passing through the bottleneck patterns abroad can be reduced.

(Modification 1)

In the above embodiment, the icons indicative of the type of the bottleneck patterns are superimposed on the map and displayed to perform the display showing the bottleneck patterns. However, the present disclosure is not limited to the above configuration. For example, a list indicative of the types of the bottleneck patterns may be displayed to perform the display of the bottleneck patterns (hereinafter referred to as “Modification 1”).

Similarly, in a configuration of Modification 1, since the driver can know what bottleneck patterns should be overcome to expand an accessible area, the driver is motivated to overcome the bottleneck patterns, and the psychological load on the driver who passes through the bottleneck patterns can be reduced.

(Modification 2)

In the above embodiment, it is determined that the immature patterns have been overcome when the number of experiences of the immature patterns reaches the predetermined number of times or more. However, the present disclosure is not always limited to the above configuration. For example, it may be determined that the immature patterns have been overcome if a deviation between a behavior of the subject vehicle when passing through the immature patterns and a behavior of a model becomes equal to or less than a predetermined value (hereinafter referred to as “Modification 2”).

The behavior of the subject vehicle may be identified from a temporal change in the value detected by a sensor for detecting the motion of the subject vehicle such as a vehicle speed sensor, an acceleration sensor, or a steering sensor. In the behavior of the model, values identified for each node pattern and each link pattern through simulation, experiment or the like in advance may be stored in a memory of the control unit 7 in advance.

(Modification 3)

In the above embodiments, it is determined whether the immature patterns have been overcome, or not, and if it is determined that the immature patterns have been overcome, a fact of overcoming is informed. However, the present disclosure is not always limited to the above configuration. For example, it is determined whether the bottleneck patterns in the immature patterns have been overcome, or not, and when it is determined that the bottleneck patterns have been overcome, information indicating that the bottleneck patterns have been overcome, and the accessible area has been expanded may be given (hereinafter, Modification 3).

In Modification 3, in the overcoming informing process described above, the processing may be limited to the bottleneck patterns stored in a bottleneck storage unit 29 among the immature patterns. If it is determined that the bottleneck patterns have been overcome, the overcome bottleneck patterns may be excluded from the bottleneck storage unit 79.

According to the configuration of Modification 3, the immature patterns informing the overcoming are limited to the bottleneck patterns in the immature patterns. Since the bottleneck patterns are the immature patterns causing the barrier of the accessible area among the immature patterns, when the bottleneck patterns are overcome, the accessible area is always expanded. According to the configuration of Modification 3, when the accessible area is expanded, since information indicating that the bottleneck patterns have been overcome, and the accessible area has been expanded is given, the driver can challenge in overcoming the immature patterns while more feeling the results of the overcoming of the immature patterns. As a result, the motivation of the driver for overcoming the immature patterns can be further enhanced.

(Modification 4)

The bottleneck patterns may be ranked according to the size of the accessible area expanded when the bottleneck patterns are to be overcome, and the ranking results may be provided to the driver (hereinafter referred to as “Modification 4”). Hereinafter, Modification 4 will be described.

A driving support system 100 according to Modification 4 is identical with the driving support system 100 according to the first embodiment except that a control unit 7 further includes a post-overcoming area identification unit 81 and a ranking unit 82, and the processing in the control unit 7 is partially different from that in the first embodiment.

<Detailed Configuration of Control Unit 7 According to Modification 4>

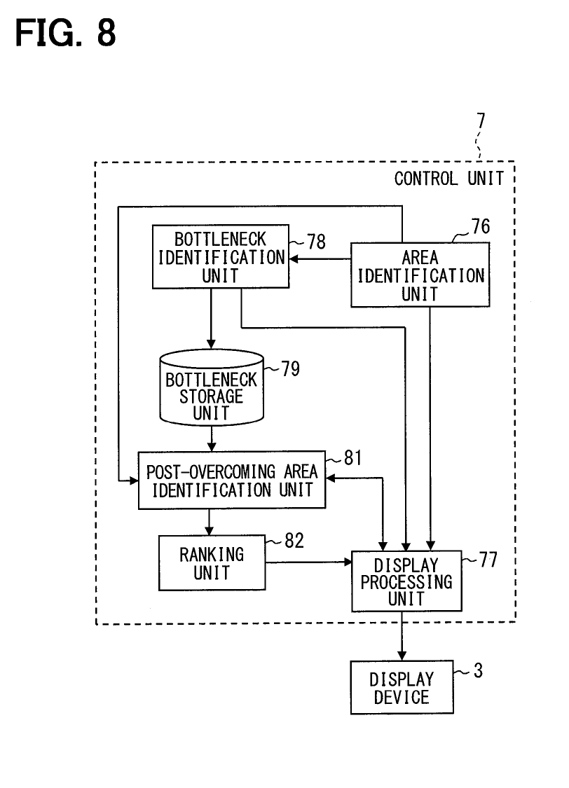

The control unit 7 according to Modification 4 will be described with reference to FIG. 8. For convenience, FIG. 8 illustrates only functional blocks required for a description of Modification 4 among the function blocks provided in the control unit 7.

The control unit 7 in Modification 4 includes a pattern determination unit 71, a learning unit 72, a count storage unit 73, a route search unit 74, an immature pattern identification unit 75, a area identification unit 76, a display processing unit 77, a bottleneck identification unit 78, a bottleneck storage unit 79, an overcoming determination unit 80, a post-overcoming area identification unit 81, and a ranking unit 82.

The post-overcoming area identification unit 81 identifies the accessible area (hereinafter referred to as “post-overcoming accessible area”) expanded when the bottleneck patterns are to be overcome. The ranking unit 82 ranks the bottleneck patterns according to the size of the accessible area expanded when the bottleneck patterns are to be overcome.

<Ranking Display Process>

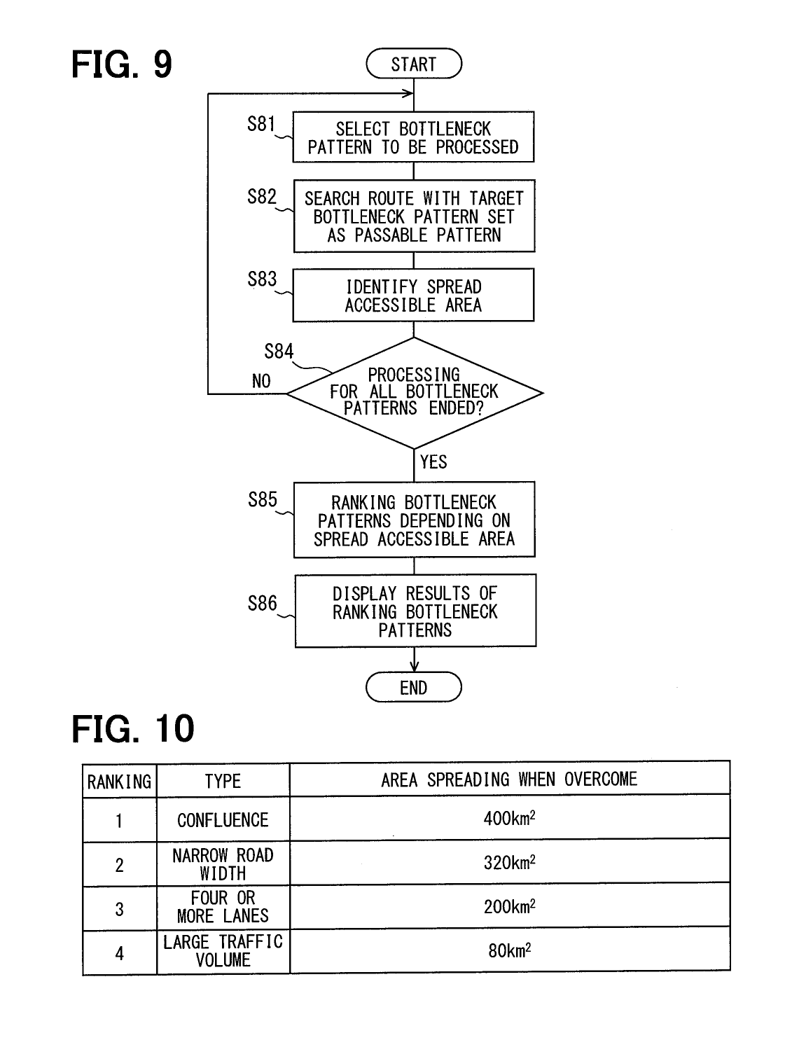

Now, a ranking display process in the control unit 7 will be described with reference to a flowchart of FIG. 9. The ranking display process may rank the bottleneck patterns according to the size of the accessible area expanded when the bottleneck patterns are to be overcome, and displays the ranking results.

As an example, the flowchart of FIG. 9 may be started when the driver requests a display of the ranking of the bottleneck patterns through the operation switch group 5. In this example, a description will be made assuming that the accessible area has already been identified by the area identification unit 76, the bottleneck patterns has already been identified by the bottleneck identification unit 78, and the identified bottleneck patterns are stored in the bottleneck storage unit 79.

First, in Step S81, the post-overcoming area identification unit 81 selects one type of bottleneck pattern from the bottleneck patterns stored in the bottleneck storage unit 79. As an example, when a list of the bottleneck patterns is stored in the bottleneck storage unit 79, the post-overcoming area identification unit 81 selects the bottleneck patterns in order of the list.

In Step S82, the bottleneck patterns selected in S81 are set to be passable whereas the remaining bottleneck patterns are set to be impassable, and the route search is further performed from a search end point when identifying the accessible area by the area identification unit 76. For example, in the case of the search end point corresponding to the bottleneck pattern selected in S81, the search end point becomes passable, and the route search is performed beyond the search end point. On the other hand, in the case of the search end point not corresponding to the bottleneck pattern selected in S81, since the search end point remains impassable, the route search is completed at the search end point.

In Step S83, the post-overcoming area identification unit 81 identifies an area surrounded by connecting the search end points of the multiple routes obtained as a result of performing the route search in S82 to each other in the same manner as that in S45 as the post-overcoming accessible area when the bottleneck patterns selected in S81 have been overcome. Hence, the post-overcoming area identification unit 81 corresponds to a post-overcoming identification unit defined in the claims.

If the post-overcoming accessible area has been identified for all of the bottleneck patterns stored in the bottleneck storage unit 79 in Step S84 (yes in S84), the process proceeds to Step S85. On the other hand, if the post-overcoming accessible area is not identified for even one type of bottleneck pattern stored in the bottleneck storage unit 79 (no in S84), the process returns to S81, and the processing is repeated for the bottleneck patterns not subjected to the identification of the post-overcoming accessible area.

In Step S85, the ranking unit 82 ranks all the bottleneck patterns stored in the bottleneck storage unit 79 according to the size of the area expanded from the accessible area identified by the area identification unit 76 on the basis of the post-overcoming accessible area identified by the post-overcoming area identification unit 81. Hence, the ranking unit 82 corresponds to a ranking identification unit defined in the claims. As an example, the bottleneck patterns may be ranked higher as a length of the expanded distance of the map network is longer, or the bottleneck patterns may be ranked higher as the size of the post-overcoming accessible area identified by the post-overcoming area identification unit 81 is larger.

In Step S86, the display device 3 is caused to display the ranking results of the ranking unit 82. The display mode of the ranking results may be configured to understand the ranking of the sizes of the accessible area expanded when the overcoming has been performed for each of the bottleneck patterns.

Now, an example of the display of the ranking result will be described with reference to FIG. 10. For example, as illustrated in FIG. 10, a list in which the type of the bottleneck patterns is associated with the size of the accessible areas expanded when the overcoming has been performed in the order of the size of the accessible area expanded when the overcoming has been performed may be displayed.

<Conclusion of Modification 4>

According to the configuration of Modification 4, since the driver can know the order of the sizes of the accessible area expanded when overcoming the bottleneck patterns for each of the bottleneck patterns, the driver can recognize the bottleneck patterns that must be overcome preferentially when the accessible area is efficiently expanded. As a result, the driver can efficiently expand the accessible area.

(Modification 5)

The accessible area expanded when overcoming the bottleneck patterns may be displayed for each of the bottleneck patterns (Modification 5). In the configuration of Modification 5, the display processing unit 77 superimposes the post-overcoming accessible area identified by the post-overcoming area identification unit 81 described above on the map for each of the bottleneck patterns, and causes the display device 3 to display the superimposed post-overcoming accessible area.

As an example, when any bottleneck pattern is selected from the list display in FIG. 10 described in Modification 4 through the operation switch group 5, the display processing unit 77 may superimposes the post-overcoming accessible area of the selected bottleneck pattern on the map, and causes the display device 3 to display the superimposed post-overcoming accessible area.

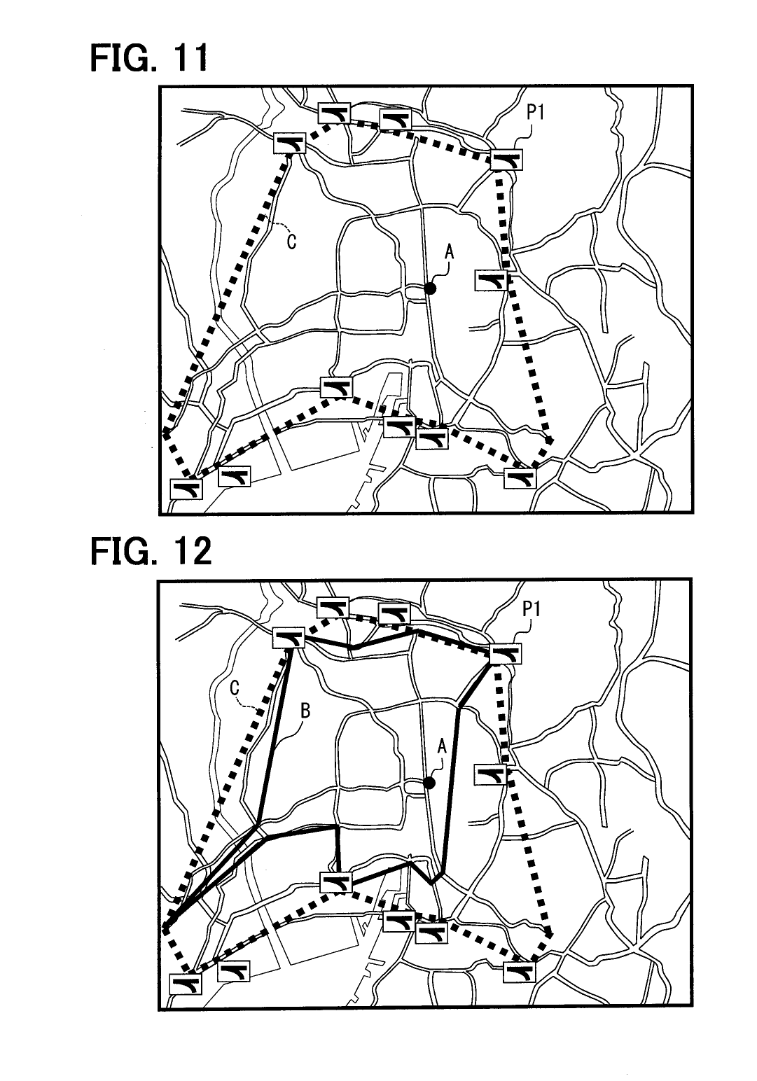

FIG. 11 illustrates an example of a display of a post-overcoming accessible area. FIG. 11 illustrates the post-overcoming accessible area when the bottleneck patterns “road width is narrow” has been overcome in the accessible area where the bottleneck patterns illustrated in FIG. 6 are “confluence” and “road width is narrow”. In FIG. 11, symbol A indicates the start point position described above, a dotted line of C indicates the post-overcoming accessible area, and P1 is icons indicative of the bottleneck patterns “confluence”.

According to the configuration of Modification 5, since the accessible area expanded when overcoming the bottleneck patterns is superimposed on the map and displayed, the driver can intuitively recognize how the accessible area is expanded when the bottleneck patterns have been overcome.

(Modification 6)

When the post-overcoming accessible area expanded when the bottleneck patterns has been overcome is superimposed on the map and displayed as in Modification 5, the post-overcoming accessible area may be displayed as comparable with the accessible area before the bottleneck patterns are overcome (hereinafter referred to as “Modification 6”). The accessible area identified in the area identification unit 76 may be used as the accessible area before the bottleneck patterns are overcome.

As an example of the mode in which the post-overcoming accessible area is displayed as comparable with the accessible area before the bottleneck patterns are overcome, as illustrated in FIG. 12, a line type (refer to C in FIG. 12) indicative of the post-overcoming accessible area is differentiated from a line type (B in FIG. 12) indicative of the accessible area before the bottleneck patterns are overcome, and those lines are superimposed on the map at the same time and displayed.

Alternatively, the post-overcoming accessible area and the accessible area before the bottleneck patterns are overcome are differentiated in color from each other, superimposed on the map at the same time, and displayed. In addition, the display of the post-overcoming accessible area and the display of the accessible area before the bottleneck patterns are overcome may be alternately replaced with each other, and displayed.

According to the configuration of Modification 6, since the accessible area before the bottleneck patterns are overcome are displayed as comparable with the accessible area expanded when the bottleneck patterns have been overcome, the driver can further intuitively recognize how the accessible area is expanded when the bottleneck patterns have been overcome.

(Modification 7)

In addition, the bottleneck patterns required to be overcome to reach a destination the driver wants to visit may be provided to the driver (hereinafter referred to as “Modification 7”). Hereinafter, Modification 7 will be described.

A driving support system 100 according to Modification 7 is identical with the driving support system 100 according to the first embodiment except that a control unit 7 further includes a destination setting unit 83 and a bottleneck extraction unit 84, and the processing in the control unit 7 is partially different from that in the first embodiment.

<Detailed Configuration of Control Unit 7 According to Modification 7>

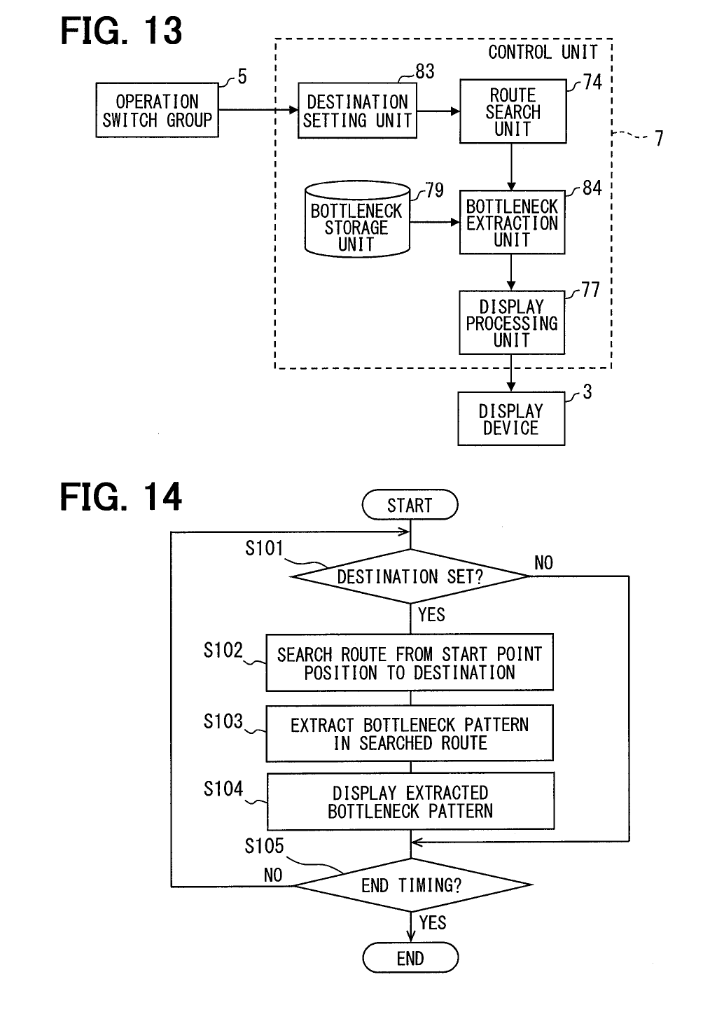

The control unit 7 according to Modification 7 will be described with reference to FIG. 13. For convenience, FIG. 13 illustrates only function blocks required for a description of Modification 7 among the functional blocks provided in the control unit 7.

The control unit 7 in Modification 7 includes a pattern determination unit 71, a learning unit 72, a count storage unit 73, a route search unit 74, an immature pattern identification unit 75, a area identification unit 76, a display processing unit 77, a bottleneck identification unit 78, a bottleneck storage unit 79, an overcoming determination unit 80, a destination setting unit 83, and a bottleneck extraction unit 84.

The destination setting unit 83 sets a place input from the driver through the operation switch group 5 to the destination. The bottleneck extraction unit 84 will be described in detail later.

<Overcoming Target Display Process>

Now, an overcoming target display process in the control unit 7 will be described with reference to a flowchart of FIG. 14. The overcoming target display process is a process for displaying the bottleneck patterns required to be overcome to reach the destination.

As an example, the flowchart of FIG. 14 is started when an ignition power of the subject vehicle turns on to power on the control unit 7. In this example, the bottleneck patterns identified by the bottleneck identification unit 78 are stored in the bottleneck storage unit 79.

First, in Step S101, if a destination is set in the destination setting unit 83 (yes in S101), the process proceeds to Step S102. On the other hand, if the destination is not set in the destination setting unit 83 (no in S101), the process proceeds to Step S105.

In Step S102, the route search unit 74 searches a recommended route from the start point position described above to the destination set by the destination setting unit 83. In the search of the recommended route, an optimum route satisfying a predetermined search condition such as a distance priority and a time priority is searched on the basis of the start point position, the destination, and the data of the map DB 2 according to a known route search method.

In Step S103, the bottleneck extraction unit 84 extracts the bottleneck patterns from the node patterns and the link patterns associated with the nodes and the links on the recommended route searched in S102 in the map DB 2 with reference to the bottleneck patterns stored in the bottleneck storage unit 79. Hence, the bottleneck extraction unit 84 corresponds to an overcoming target identification unit defined in the claims.

In Step S104, the display processing unit 77 causes the display device 3 to display the bottleneck patterns extracted in S103. The bottleneck patterns extracted in S103 correspond to overcoming target patterns defined in the claims.

As a display mode of the extracted bottleneck patterns, the bottleneck patterns may be listed in the appearing order when traveling on the recommended route from the start point position to the destination. Icons indicative of the type of the bottleneck patterns may be displayed at the positions of the bottleneck patterns on the recommended route shown on the map. In addition, the types of the extracted bottleneck patterns may be simply listed.

In Step S105, if it is an end timing of the overcoming target display process (yes in S105), the overcoming target display process is completed. If it is not the end timing of the overcoming target display process (no in S105), the process returns to S101, and the processing is repeated. An example of the end timing of the overcoming target display process is a timing when an ignition power supply of the subject vehicle is turned off to power off the control unit 7.

<Conclusion of Modification 7>

According to the configuration of Modification 7, if the driver inputs the destination where the driver wants to visit through the operation switch group 5, the driver can know the bottleneck patterns required to be overcome to reach the destination from the start point position. Since the bottleneck patterns required to be overcome to reach the destination where the driver wants to visit are considered particularly as the bottleneck patterns causing the driver to easily enhance the motivation for the overcoming, the drive can more aggressively challenge the overcoming of the bottleneck patterns.

(Modification 8)

Information on facilities at which the driver can newly arrive when the bottleneck patterns are to be overcome may be provided to the driver (hereinafter referred to as Modification 8). Hereinafter, Modification 8 will be described.

A driving support system 100 according to Modification 8 is identical with the driving support system 100 according to the first embodiment except that a control unit 7 further includes a post-overcoming area identification unit 81, a post-overcoming area selection unit 85 and a facility identification unit 86, and the processing in the control unit 7 is partially different from that in the first embodiment.

<Detailed Configuration of Control Unit 7 According to Modification 8>

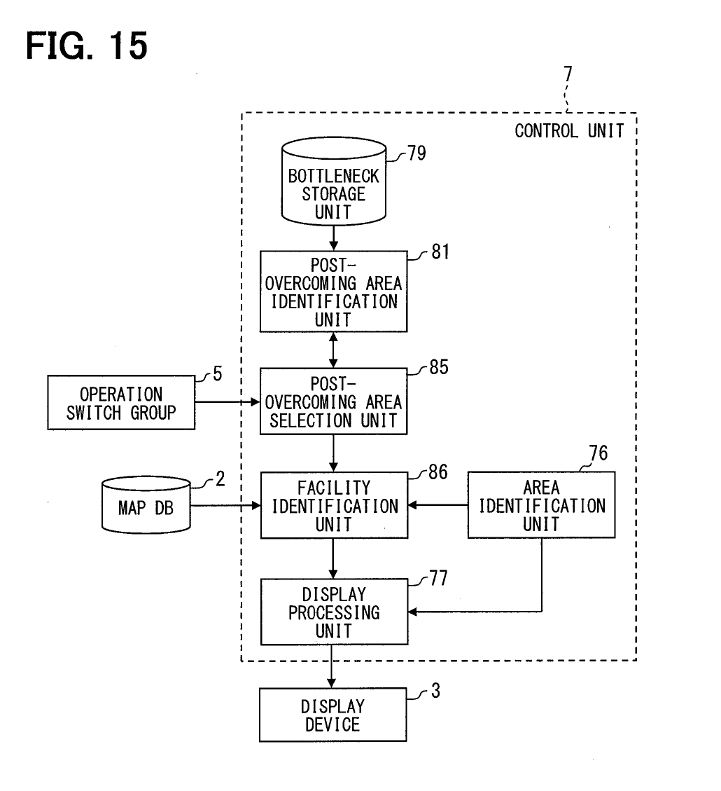

The control unit 7 according to Modification 8 will be described with reference to FIG. 15. For convenience, FIG. 15 illustrates only function blocks required for a description of Modification 8 among the functional blocks provided in the control unit 7.

The control unit 7 in Modification 8 includes a pattern determination unit 71, a learning unit 72, a count storage unit 73, a route search unit 74, an immature pattern identification unit 75, a area identification unit 76, a display processing unit 77, a bottleneck identification unit 78, a bottleneck storage unit 79, an overcoming determination unit 80, a post-overcoming area identification unit 81, a post-overcoming area selection unit 85, and a facility identification unit 86.

The post-overcoming area identification unit 81 is the same as that described in Modification 4. The post-overcoming area selection unit 85 selects the post-overcoming accessible area of the bottleneck pattern requested from the driver through the operation switch group 5 from the post-overcoming accessible area identified by the post-overcoming area identification unit 81. The facility identification unit 86 identifies facilities newly reachable when the accessible area identified by the area identification unit 76 expands to the post-overcoming accessible area selected by the post-overcoming area selection unit 85.

<Overcoming Time Arrival Facility Display Process>

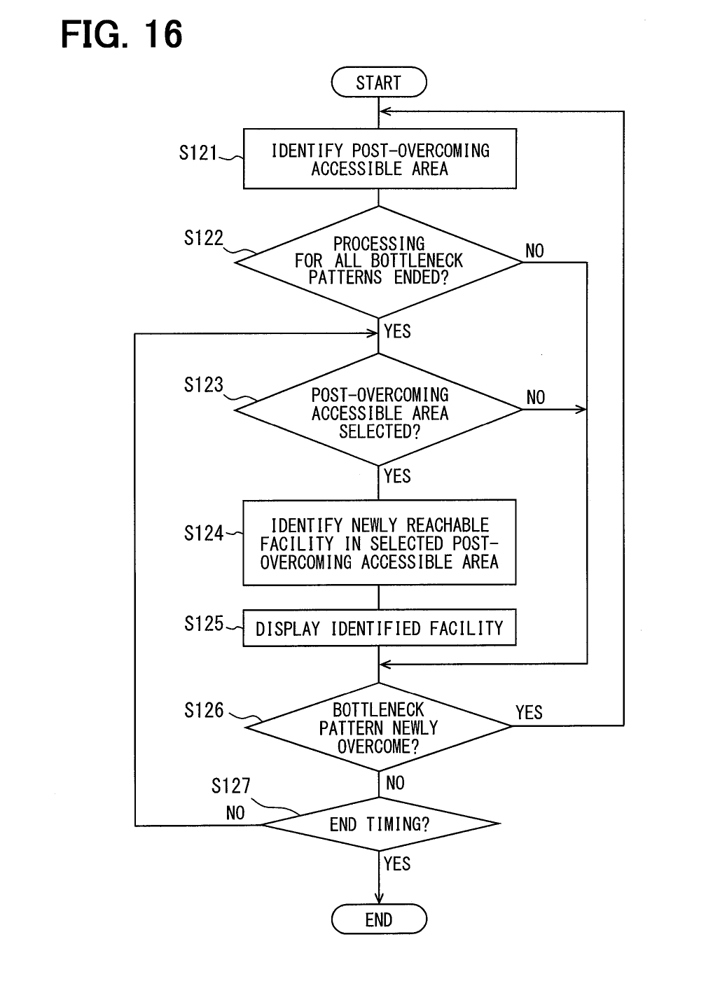

Now, an overcoming time arrival facility display process by the control unit 7 will be described with reference to a flowchart of FIG. 16. The overcoming time arrival facility display process is a process for displaying information on the facilities newly reachable by the driver when the bottleneck patterns are to be overcome.

As an example, the flowchart of FIG. 16 may be started when an ignition power of the subject vehicle turns on to power on the control unit 7. In this example, the bottleneck patterns identified by the bottleneck identification unit 78 are stored in the bottleneck storage unit 79.

First, in Step S121, as described in Modification 4, the post-overcoming area identification unit 81 identifies the post-overcoming accessible area. If the post-overcoming accessible area has been identified for all of the bottleneck patterns stored in the bottleneck storage unit 79 in Step S122 (yes in S122), the process proceeds to Step S123. On the other hand, if the post-overcoming accessible area is not identified for the bottleneck patterns stored in the bottleneck storage unit 79 (no in S122), the process proceeds to Step S125.

In Step S123, if the post-overcoming accessible area has been selected in the post-overcoming area selection unit 85 (yes in S123), the process proceeds to Step S124. On the other hand, if the post-overcoming accessible area is not selected in the post-overcoming area selection unit 85 (no in S123), the process proceeds to Step S125.

In Step S124, the facility identification unit 86 identifies facilities newly reachable when the accessible area identified by the area identification unit 76 expands to the post-overcoming accessible area selected by the post-overcoming area selection unit 85.

As an example, several facilities higher in ranking of the number of customer arrivals or evaluation are identified from the facilities located in an area obtained by subtracting the accessible area identified by the area identification unit 76 from the post-overcoming accessible area selected by the post-overcoming area selection unit 85 on the basis of the POI data in the map DB 2. In addition, the facilities identical in type with the facilities frequently used by the driver may be identified. The facilities identical in the type with the facilities higher in the ranking of the number of customer arrivals or the evaluation or the facilities frequently used by the driver are recommended facilities presumed to be of interest to the driver.

In Step S125, the display processing unit 77 causes the display device 3 to display the information on the facilities identified in S124. As the display mode of the facility information, facility names or icons indicative of the facilities are displayed at the positions of the facilities on the map, or texts describing the content of the facilities may be displayed.

In Step S126, when the types of bottleneck patterns stored in the bottleneck storage unit 79 are reduced, and the bottleneck patterns are newly overcome (yes in S126), the process returns to S121, and the processing is repeated. On the other hand, if it is determined that the bottleneck pattern is not newly overcome (no in S126), the process proceeds to Step S127.

In Step S127, if it is an end timing of the overcoming time arrival facility display process (yes in S127), the overcoming time arrival facility display process is completed. If it is not the end timing of the overcoming time arrival facility display process (no in S127), the process returns to S121, and the processing is repeated. An example of the end timing of the overcoming time arrival facility display process is a timing when an ignition power supply of the subject vehicle is turned off to power off the control unit 7.

<Conclusion of Modification 8>

According to the configuration of Modification 8, the recommended facilities presumed to be of interest to the driver, which are newly reachable when the bottleneck patterns have been overcome, are displayed, as a result of which the motivation of the driver who overcomes the bottleneck patterns required to be overcome so as to reach the recommended facilities can be enhanced. As a result, the driver can more aggressively challenge the overcoming of the bottleneck patterns.

(Modification 9)

The various processes described above may be performed for each of the drivers. For example, the experience number learning process may be performed for each driver, and the number of experiences of the node patterns and the link patterns may be stored for each driver. The immature patterns for each driver may be identified to display the accessible area for each driver. The bottleneck patterns may be stored for each driver to display the post-overcoming accessible area for each driver.

With the use of a weight scale or a pressure sensor, for example, installed in a seat part of a driver's seat, the individual drivers may be identified from a weight measured by the weight scale or a detection value by the pressure sensor. In addition, the individual drivers may be identified by IDs received from electronic keys.

According to the configuration of Modification 9, even when the same vehicle is shared by multiple drivers, a support for providing the accessible area or the post-overcoming accessible area corresponding to the driving experience of each driver can be performed.

(Modification 10)

The driving support system 100 may be configured by, for example, a mobile terminal such as a multi-function cellular phone having a GPS function.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A driving assistance device used for a vehicle comprising:
a display processing device that displays a map on a display device;
an immature pattern identification device that identifies an immature pattern inexperienced by a driver of the vehicle, based on a link that the vehicle travels, among a plurality of patterns with predetermined types into which a plurality of links as a plurality of components of a road network included in the map are classified; and
an accessible area identification device that identifies an accessible area to which the vehicle is reachable from a set start point without passing through the immature pattern identified by the immature pattern identification device, wherein:
the display processing device controls the display device to superimpose the accessible area identified by the accessible area identification device is on the map displayed on the display device.

2. The driving assistance device according to claim 1, further comprising:
an overcoming determination device that determines whether the driver overcomes the immature pattern, wherein:
the immature pattern identification device does not identify the immature pattern, which is determined to be overcome by the overcoming determination device, as the immature pattern.

3. The driving assistance device according to claim 2, wherein:
the display processing device controls the display device to display a feature that the driver overcomes the immature pattern when the overcoming determination device determines that the driver overcomes the immature pattern.

4. The driving assistance device according to claim 1, wherein:
the display processing device controls the display device to display a barrier pattern as the immature pattern which provides a cause for limiting and identifying the accessible area with the accessible area identification device.

5. The driving assistance device according to claim 4, wherein:
the display processing device controls the display device to display the barrier pattern at a position of the barrier pattern which is a boundary point of the accessible area, the barrier pattern being superimposed on the accessible area identified by the accessible area identification device.

6. The driving assistance device according to claim 4, wherein:
the immature pattern identification device identifies a plurality of types of the immature pattern;
the driving assistance device further comprising:
a ranking identification device that identifies a ranking of the plurality of types of the barrier pattern corresponding to a size of the accessible area expanded when the driver overcomes each type of the barrier pattern in a case where the plurality of types of the barrier pattern exists, wherein:
the display processing device controls the display device to display the ranking of the plurality of types of the barrier pattern identified by the ranking device when the plurality of types of the barrier pattern exists.

7. The driving assistance device according to claim 4, further comprising:
a post-overcoming identification device that identifies a post-overcoming accessible area that is the accessible area assuming that the driver overcomes the barrier pattern, wherein:
the display processing device controls the display device to display the map on which the post-overcoming accessible area identified by the post-overcoming identification device is superimposed.

8. The driving assistance device according to claim 7, wherein:
the immature pattern identification device identifies a plurality of types of the immature pattern;
when the plurality of types of the barrier pattern exists, the post-overcoming identification device identifies the post-overcoming accessible area of each of the plurality of types of the barrier pattern, individually; and
the display processing device controls the display device to display the post-overcoming accessible area for each of the plurality of types of the barrier pattern.

9. The driving assistance device according to claim 7, wherein:
the display processing device controls the display device to display the accessible area before assuming that the driver overcomes the barrier pattern and the post-overcoming accessible area in a comparable manner.

10. The driving assistance device according to claim 4, further comprising:
a facility identification device that identifies a recommended facility which is assumed to be of interest to the driver, and is newly reachable when assuming that the driver overcomes the barrier pattern, wherein:
the display processing device controls the display device to display a feature that the driver reaches the recommended facility identified by the facility identification device when the driver overcomes the barrier pattern.

11. The driving assistance device according to claim 1, further comprising:
a destination setting device that sets a destination based on an input operation of the driver; and
an overcoming target identification device that identifies an overcoming target pattern, which is the immature pattern that is to be overcome by the driver in order to reach the destination set by the destination setting device, from the immature pattern identified by the immature pattern identification device, wherein:
the display processing device controls the display device to display a feature that it is necessary to overcome the overcoming target pattern identified by the overcoming target identification device in order to reach the destination.

12. The driving assistance device according to claim 1, further comprising:
a route search device that searches a route reachable by the vehicle from the set start point without passing through the immature pattern identified by the immature pattern identification device, wherein:
the accessible area identification device identifies an area, surrounded by connecting end points of a plurality of routes searched by the route search device to each other, as the accessible area.
